(19) United States
(12) Patent Application Publication
(10) Pub. No.: US 2011/0073591 A1
(43) Pub. Date: Mar. 31, 2011

(54) Guide Chip Structure for High-Frequency Induction Heating Coil

(76) Inventor: Seiichi Sawatsubashi, Tokyo (JP)

(21) Appl. No.: 12/994,931

(22) PCT Filed: Jul. 17, 2008
(86) PCT No.: PCT/JP2008/062891

§ 371 Date: Nov. 29, 2010

(51) Int. Cl. H05B 6/10

(52) U.S. Cl. 219/672

(57) ABSTRACT

To provide a structure of guide chips for high frequency induction heating coil which makes it possible to correctly position the guide chips for high frequency induction heating coil in the width direction of a journal portion or a pin portion of a crankshaft and which thus makes it possible to correctly position a semi-open saddle type high frequency induction heating coil in the width direction of the journal portion or the pin portion.

Each of guide chips 21a to 21c includes: respective pairs of flexible bodies 24a to 24c, which pair are respectively provided in side plates 7 and 7, and have a spring function; a pair of chips 29a and 29a which are arranged and fixed in the inside of the pair of flexible bodies facing each other; and a pair of chip fixing plates 30a and 30a which are respectively arranged and fixed in the inside the pair of chips. Furthermore, the guide chips 21a to 21c are also configured such that in a free state, a gap 32 exists between the inner surfaces of the pair of chip fixing plates, and also the width dimension between the external surfaces of the pair of chips is set to become larger than the width dimension of a journal portion 2 or a pin portion 4, and such that when the guide chips are inserted between counterweight portions 3 and 3 adjacent to each other, the gap 32 is reduced or eliminated by the spring function of the pair of flexible bodies.

### TECHNICAL FIELD

The present invention relates to a structure of a plurality of guide chips for high frequency induction heating coil which are respectively attached between a pair of side plates for supporting a semi-open saddle type high frequency induction heating coil, and which, when a journal portion or a pin portion of a crankshaft is subjected to high frequency induction heating by the semi-open saddle type high frequency induction heating coil, are used for positioning the center of the journal portion or the pin portion with respect to the semi-open saddle type high frequency induction heating coil, and used for positioning the semi-open saddle type high frequency induction heating coil in the width direction of the journal portion or the pin portion between mutually adjacent counterweight portions of the crankshaft. More particularly, the present invention relates to a structure of a plurality of guide chips for high frequency induction heating coil in which the structure enables the non-hardened area of the hardened case formed in the journal portion or the pin portion to fully satisfy the range of the specification.

### BACKGROUND ART

As shown in FIG. 9, a crankshaft 1 which is an object to be heated is configured by a journal portion 2 serving as a central shaft, counterweight portions 3 arranged between the journal portions 2 adjacent to each other, and a pin portion 4 provided between the counterweight portions 3 facing each other, and the like. The journal portion 2 and the pin portion 4 are subjected to high frequency induction heating so as to be hardened. As the hardening methods, there are flat hardening and filet R hardening. In any of the methods, a hardened case needs to be correctly formed in the journal portion 2 or the pin portion 4. Note that as a high frequency induction heating apparatus for applying high frequency induction heating to the journal portion 2 or the pin portion 4, there is conventionally adopted, for example, an apparatus as shown in FIG. 1 of Japanese Patent Laid-Open No. 2002-226919 (patent document 1).

The high frequency induction heating apparatus as described in Japanese Patent Laid-Open No. 2002-226919 is configured as shown in FIG. 1 in Japanese Patent Laid-Open No. 2002-226919. FIG. 10 shows a high frequency induction heating apparatus 6 which is similar to the apparatus shown in FIG. 1 in Japanese Patent Laid-Open No. 2002-226919, and which uses a semi-open saddle type high frequency induction heating coil 5.

As shown in FIG. 10, the high frequency induction heating apparatus 6 includes a pair of side plates 7 which are connected to the apparatus main body side so as to be arranged to face each other, the semi-open saddle type high frequency induction heating coil 5 which is arranged in a lower end side opening portion of the side plate 7 so as to be supported by the side plate 7, guide chips 8a, 8b and 8c for high frequency induction heating coil which are arranged at predetermined places (in the present example, three places of the upper side portion with respect to the center line of the journal portion 2 of the crankshaft 1, and of the left and right side portions with respect to the center line of the journal portion 2) corresponding to the semi-open saddle type high frequency induction heating coil 5, so as to be attached to the side plate 7, and the like. Furthermore, in the high frequency induction heating apparatus 6, a power supply lead conductor 9 is connected to the semi-open saddle type high frequency induction heating coil 5, and cooling water supply means 10 for quickly cooling a heated portion of the crankshaft 1, and the like, is provided. The guide chips 8a, 8h and 8c for high frequency induction heating coil are members provided so that a predetermined gap (about 0.5 mm to 3.5 mm) is secured between the journal portion 2 (or the pin portion 4) of the crankshaft 1 and the semi-open saddle type high frequency induction heating coil 5 at the time when the journal portion 2 (or the pin portion 4) is subjected to high frequency induction heating by the semi-open saddle type high frequency induction heating coil 5. In addition, the guide chips 8a, 8b and 8c are configured such that the semi-open saddle type high frequency induction heating coil 5 is mounted, via the guide chips 8a, 8b and 8c, on the journal portion 2 (or the pin portion 4) which is rotated about the axis line of the crankshaft 1 (the center line of the journal portion 2). At this time, the center of the journal portion 2 (or the pin portion 4) is positioned with respect to the semi-open saddle type high frequency induction heating coil 5 by abutting action of the guide chips 8a, 8b and 8c on the outer peripheral surface of the journal portion 2.
Patent document 1: Japanese Patent Application Laid-Open No. 2002-226919

### DISCLOSURE OF THE INVENTION

### Problems to be Solved by the Invention

The guide chips 8a, 8b and 8c for high frequency induction heating coil which are provided in the conventional high frequency induction heating apparatus 6 having the above-described structure are usually configured by components as shown in FIG. 11(a) and FIG. 11(b). That is, each of the guide chips 8a, 8b and 8c is configured by the side plates 7 and 7 which are arranged so as to face each other via a gap 11, chips 12 and 12 which are respectively arranged in contact with the inner surfaces of the side plates 7 and 7, a chip fixing plate 13 provided between the chips 12 and 12, screws 14 and 14 which integrally and closely fix the side plates 7 and 7, the chips 12 and 12, and the chip fixing plate 13 to each other, and the like. Here, the width dimension L₁ (see FIG. 11(a)) between the outer surfaces of the chips 12 and 12 is fixed (cannot be changed), and hence it is necessary to make the width dimension L₁ almost equal to the width dimension L₂ or L₃ (see FIG. 9) of the journal portion 2 or the pin portion 4 of the crankshaft 1.

However, in the case in which the width dimension L₁ is made completely equal to, for example, the width dimension L₂ of the journal portion 2, when the guide chips 8a, 8b and 8c are inserted between the counterweight portions 3 and 3 on both sides of the journal portion 2 so as to be mounted on the journal portion 2, the guide chips 8a, 8b and 8c are not smoothly inserted. Thus, the width dimension L₁ must be set slightly smaller than the width dimension L₂. Furthermore, even if there are used the guide chips for high frequency induction heating coil, which have the same width dimension L₁ as the width dimension L₂ of a journal portion 2 of a crankshaft 1 of a certain type, in the case in which the same guide chips for high frequency induction heating coil are also used for a crankshaft 1 of another type which has substantially similar dimensions and in which the journal portion 2 has the same outside diameter dimension but has a width dimension slightly larger than the width dimension L₂, a gap is generated between the counterweight portion 3 of the crankshaft 1 and the guide chip for high frequency induction heating coil. FIG. 12(a) shows a state in which a gap δ is generated between the outer surface of the chip 12 and the inner surface of the counterweight portion 3, and shows a case in which the gap δ is generated because the width dimension L₁ of the guide chip 8a (and 8b, 8c) for high frequency induction heating coil is smaller than the width dimension L₂ of the journal portion 2. In this case, the semi-open saddle type high frequency induction heating coil 5 is arranged so as to face the outer peripheral surface of the journal portion 2 at a position shifted from the width-direction central position of the journal portion 2 similarly to the guide chip 8a (and 8b, 8c) for high frequency induction heating coil.

When the outer peripheral surface of the journal portion 2 is subjected to high frequency induction heating for flat hardening while the crankshaft 1 is rotated about the axis line thereof (the center line of the journal portion 2) in the state in which the gap δ exists as described above, a hardened case S₁ is formed at a position shifted from the center in the width direction of the journal portion 2 (for example, at a position shifted to the right side) as shown in FIG. 12(b). This causes a problem in that the dimensions α and β between each end portion of the hardened case S₁ and the inner surfaces of the counterweight portion 3 are different from each other. The dimensions α and β are referred to as “non-hardened areas”, and a specification is specified for the dimension. However, there arises a case in which the dimensions α and β do not satisfy the specification.

Furthermore, in the case in which the outer peripheral surface of the journal portion 2 is subjected to high frequency induction heating for fillet R hardening while the crankshaft 1 is rotated about the axis line thereof, when there is the gap δ between the guide chip 8a (and 8b, 8c) for high frequency induction heating coil and the counterweight portion 3 of the crankshaft 1 as shown in FIG. 12(c), the guide chip 8a (and 8b, 8c) for high frequency induction heating coil is not correctly positioned in the width direction of the journal portion 2. Therefore, the semi-open saddle type high frequency induction heating coil 5 is also not correctly positioned, so as to thereby cause a difference between case depths t₁ and t₂ at corner portions of a hardened case S₂ formed by the fillet R hardening, as shown in FIG. 12(d). As a result, there arises a case in which the values of the case depths t₁ and t₂ do not satisfy the specification.

The present invention has been made in order to solve the above-described problem. An object of the present invention is to provide the structure of the guide chips for high frequency induction heating coil, in which structure the guide chips for high frequency induction heating coil can always be correctly positioned in the width direction of the journal portion or the pin portion of the crankshaft, and hence the semi-open saddle type high frequency induction heating coil 5 can always be correctly positioned in the above-described width direction, and in which structure the non-hardened area in the case of flat hardening, and the case depth at the corner portion of the hardened case in the case of fillet R hardening can satisfy the specifications, and thereby the precise hardening can be performed.

### Means for Solving the Problems

In order to achieve the above-described object, according to the present invention, there is provided a structure of a plurality of guide chips for high frequency induction heating coil, which are respectively attached between a pair of side plates for supporting a semi-open saddle type high frequency induction heating coil, which when a journal portion or a pin portion of a crankshaft is subjected to high frequency induction heating by the semi-open saddle type high frequency induction heating coil, are used for positioning the center of the journal portion or the pin portion with respect to the semi-open saddle type high frequency induction heating coil, and which are used for positioning the semi-open saddle type high frequency induction heating coil in the width direction of the journal portion or the pin portion between the mutually adjacent counterweight portions of the crankshaft, the structure being characterized in that the guide chip for high frequency induction heating coil includes: a pair of flexible bodies which have a spring function and are respectively provided in the pair of side plates; a pair of chips which are respectively arranged and fixed in the inside of the pair of flexible bodies facing each other; and a pair of chip fixing plates which are respectively arranged and fixed in the inside of the pair of chips, and characterized by being configured such that, in a free state in which the guide chip for high frequency induction heating coil is not inserted between the mutually adjacent counterweight portions, a gap exists between the inner surfaces of the pair of chip fixing plates facing each other and thereby the width dimension between the outer surfaces of the pair of chips facing each other is set larger than the width dimension of the journal portion or the pin portion, and such that when the guide chip for high frequency induction heating coil is inserted between the mutually adjacent counterweight portions, the gap between the inner surfaces of the pair of chip fixing plates is reduced or eliminated by the spring function of the pair of flexible bodies.

Furthermore, according to the present invention, it is configured such that the flexible body is integrally provided to the side plate by forming, in the side plate, a pair of slits that are arranged at a distance so as to face each other and that are extended to an opening portion of the side plate in which portion the journal portion or the pin portion is inserted and arranged.

Furthermore, according to the present invention, it is configured such that the guide chips for high frequency induction heating coil are arranged at three places of the upper side and the left and right sides with respect to the center line of the journal portion or the pin portion, and such that the flexible body is provided at all or at least one of the three places in which the three guide chips for high frequency induction heating coil are arranged.

### ADVANTAGES OF THE INVENTION

In the first aspect of the present invention, the guide chip for high frequency induction heating coil includes: a pair of flexible bodies which have a spring function and are respectively provided in a pair of side plates; a pair of chips which are respectively arranged and fixed in the inside of the pair of flexible bodies facing each other; and a pair of chip fixing, plates which are respectively arranged and fixed in the inside of the pair of chips, and is configured such that, in a free state in which the guide chip for high frequency induction heating coil is not inserted between the mutually adjacent counterweight portions of the crankshaft, a gap exists between the inner surfaces of the pair of chip fixing plates facing each other and thereby the width dimension between the outer surfaces of the pair of chips facing each other is set larger than the width dimension of the journal portion or the pin portion, and such that when the guide chip for high frequency induction heating coil is inserted between the mutually adjacent counterweight portions, the gap between the inner surfaces of the pair of chip fixing plates is reduced or eliminated by the spring function of the pair of flexible bodies. Thus, with the structure of the guide chip for high frequency induction heating coil according to the present invention, it is possible to obtain the following operation effects. That is, the guide chip for high frequency induction heating coil is configured as a flexible member (whose width dimension can be changed). Thus, when the guide chip for high frequency induction heating coil is inserted between the counterweight portions adjacent to each other in the width direction of the journal portion or the pin portion, the guide chip for high frequency induction heating coil, which has, in the free state, the width dimension larger than the width dimension between the mutually adjacent counterweight portions, is elastically deformed so that the gap between the inner surfaces of the pair of chip fixing plates is reduced by the spring function of the flexible bodies of the side plates. As a result, the pair of chips are inserted and arranged between the mutually adjacent counterweight portions, so as to be brought into press contact with the respective counterweight portions. Thereby, the guide chip for high frequency induction heating coil can always be correctly positioned in the width direction of the journal portion or the pin portion between the mutually adjacent counterweight portions. Thus, the semi-open saddle type high frequency induction heating coil can always be correctly positioned in the width direction of the journal portion or the pin portion. Thereby, the non-hardened area can be stably suppressed to be within the specification. Furthermore, by suitably setting the flexible range of the above-described flexible body, the same guide chip for high frequency induction heating coil can also be used for a crankshaft in which the journal portion or the pin portion has the same outside diameter dimension but has a slightly different width dimension.

Furthermore, in the second aspect of the present invention, it is configured such that the flexible body is integrally provided to the side plate by forming, in the side plate, a pair of slits which are arranged at a distance so as to face each other and which are extended to the opening portion of the side plate in which portion the journal portion or the pin portion is inserted. Thus, it is not necessary to provide a flexible body configured by a member which is separate from the side plate. Therefore, it is possible to facilitate the manufacturing of the high frequency induction heating apparatus.

Furthermore, in the third aspect of the present invention, it is configured such that the guide chips for high frequency induction heating coil are arranged at three places of the upper side and the left and right sides with respect to the center line of the journal portion or the pin portion, and such that the flexible body is provided at all or at least one of the three places in which the three guide chips for high frequency induction heating coil are arranged. Hence, it is obvious that, when all the guide chips arranged at the three places are made flexible, the guide chips for high frequency induction heating coil and thus the semi-open saddle type high frequency induction heating coil can be surely positioned in the width direction of the journal portion or the pin portion. Furthermore, even when at least one of the guide chips arranged at the three places are made flexible, the above-described positioning in the width direction can be performed more correctly than before, so that the non-hardened area can be suppressed to be within the specification.

### BRIEF DESCRIPTION OF THE DRAWINGS

FIG. 1 is a front view showing a high frequency induction heating apparatus having a structure of guide chips for a high frequency induction heating coil according to an embodiment of the present invention;

FIG. 2 is a front view showing a side plate of the high frequency induction heating apparatus shown in FIG. 1, in a state in which the guide chips for high frequency induction heating coil are attached to the side plate;

FIG. 3 shows a structure of the guide chip for high frequency induction heating coil according to the present invention;

FIG. 3(a) is a sectional view of the guide chip for high frequency induction heating coil taken along the line A-A in FIG. 3(b);

FIG. 3(b) is a side view showing a place at which the guide chip for high frequency induction heating coil is attached to the side plate;

FIG. 4 shows a relationship of the guide chip for high frequency induction heating coil with a journal portion and a counterweight portion of a crankshaft;

FIG. 4(a) is a sectional view showing the guide chip for high frequency induction heating coil in a free state;

FIG. 4(b) is a sectional view showing a state in which the guide chip for high frequency induction heating coil is inserted between the mutually adjacent counterweight portions;

FIG. 5 is a sectional view showing a state in which a hardened case is formed in a portion without an oil hole in the journal portion by using the guide chip for high frequency induction heating coil according to the present embodiment;

FIG. 6 is a sectional view showing a state in which a hardened case is formed in a portion with an oil hole in the journal portion by using the guide chip for high frequency induction heating coil;

FIG. 7 is a graph showing non-hardened areas formed in the portion without the oil hole in the journal portions by using the guide chip for high frequency induction heating coil according to the present embodiment and by using a conventional guide chip for high frequency induction heating coil;

FIG. 8 is a graph showing non-hardened areas formed in the portion with the oil hole in the journal portions by using the guide chips for high frequency induction heating coil according to the present embodiment;

FIG. 9 is a side view of a crankshaft;

FIG. 10 is a side view showing a main portion of a high frequency induction heating apparatus having the conventionally configured guide chips for high frequency induction heating coil;

FIG. 11 shows a structure of the conventional guide chip for high frequency induction heating coil;

FIG. 11(a) is a sectional view of the conventional guide chip for high frequency induction heating coil taken along the line B-B in FIG. 11(b);

FIG. 11(b) is a front view of the conventional guide chip for high frequency induction heating coil;

FIG. 12 is a sectional view showing a hardening method of the journal portion of the crankshaft, using the conventional guide chip for high frequency induction heating coil;

FIG. 12(a) is a sectional view showing a state in flat hardening;

FIG. 12(b) is a sectional view showing a hardened case formed in the journal portion by the flat hardening;

FIG. 12(c) is a sectional view showing a state in fillet R hardening; and

FIG. 12(d) is a sectional view showing a hardened case formed in the journal portion by the fillet R hardening.

### DESCRIPTION OF SYMBOLS

1 Crankshaft
2 Journal portion
3 Counterweight portion
4 Pin portion
5 Semi-open saddle type high frequency induction heating coil
7 Side plate
20 High frequency induction heating apparatus
21a, 21b, 21c Guide chip for high frequency induction heating coil
22 Semicircular arc-shaped opening portion
23 Slit
24a, 24b, 24c Flexible body
25, 26 Slit
29a Chip
30a Chip fixing plate
31a Screw
32 Gap

### BEST MODE FOR CARRYING OUT THE INVENTION

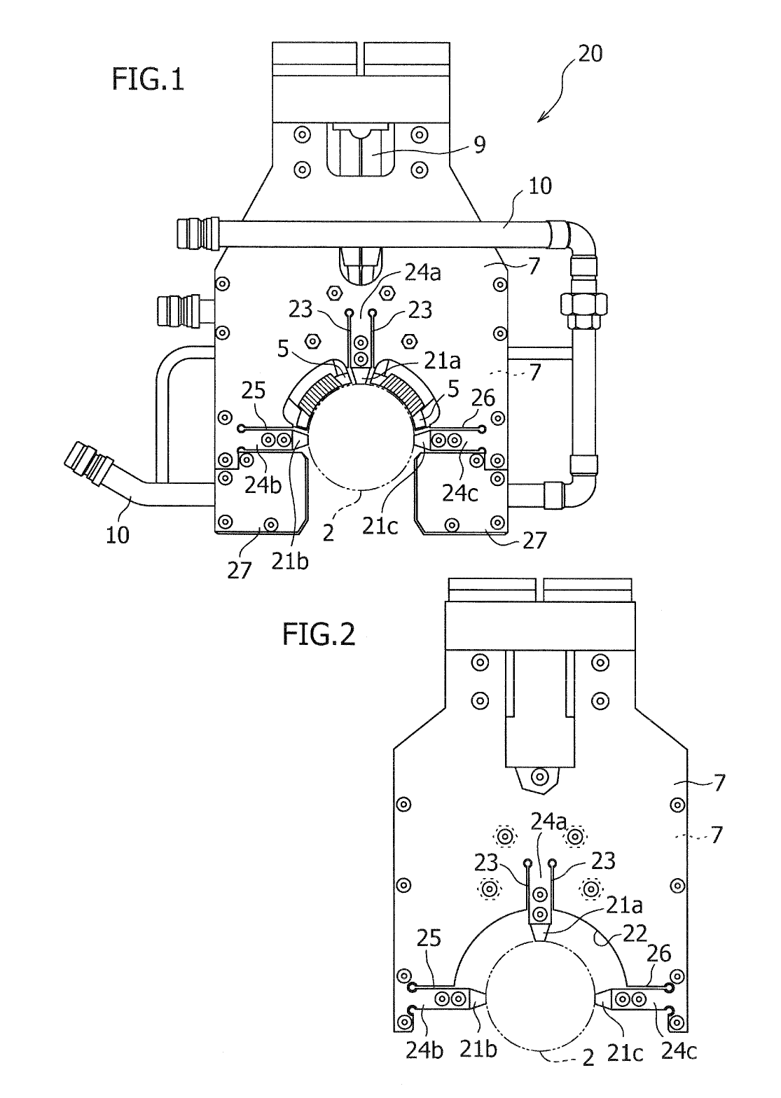

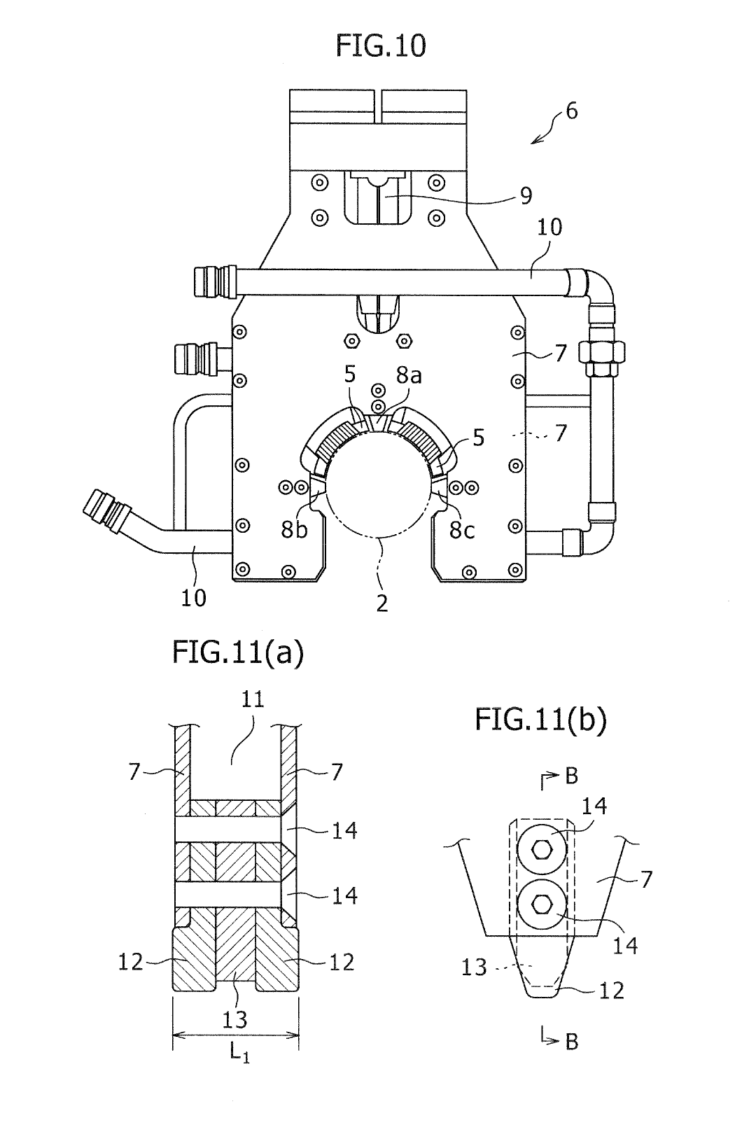

In the following, there will be described a structure of guide chips for a high frequency induction heating coil according to an embodiment of the present invention with reference to FIG. 1 to FIG. 8. Note that in FIG. 1 to FIG. 8, the same portions as those in FIG. 9 to FIG. 12 are denoted by the same reference numerals and characters, and the repeated explanation thereof is omitted.

FIG. 1 shows a high frequency induction heating apparatus 20 having a structure of guide chips for a high frequency induction heating coil according to an embodiment of the present invention. The high frequency induction heating apparatus 20 is configured to apply high frequency induction heating to a journal portion 2 of a crankshaft 1. As shown in FIG. 1, the high frequency induction heating apparatus 20 includes a pair of side plates 7 which are respectively connected to the side of a transformer (not shown) and which are arranged so as to face each other, a semi-open saddle type high frequency induction heating coil 5 which is arranged at a lower end side opening portion of the side plate 7 so as to be supported by side plate 7, a power supply lead conductor 9 which supplies high frequency power to the semi-open saddle type high frequency induction heating coil 5 from a power source (not shown), and three guide chips 21a, 21b and 21c for high frequency induction heating coil which are attached at predetermined positions of the side plate 7 in correspondence with the semi-open saddle type high frequency induction heating coil 5 (in the present embodiment, at three places of the upper side portion with respect to the center line of the journal portion 2 of the crankshaft 1, and of the left and right side portions with respect to the center line of the journal portion 2). Furthermore, the high frequency induction heating apparatus 20 is provided with cooling water supply means 10 for spraying cooling water for hardening treatment to the journal portion 2 which is subjected to high frequency induction heating by the semi-open saddle type high frequency induction heating coil 5. Note that FIG. 2 is a front view of the side plate 7 for representing the structure of the three guide chips 21a, 21b and 21c for high frequency induction heating coil, which are main components of the present embodiment.

The three guide chips 21a, 21b and 21c for high frequency induction heating coil are respectively attached between the pair of side plates 7 and 7 for supporting the semi-open saddle type high frequency induction heating coil 5. The three guide chips 21a, 21b and 21c are arranged so as to be brought into contact with the upside portion and the left and right side portions of the journal portion 2 of the crankshaft 1 which journal portion is driven and rotated about the center line of the journal portion 2 by a rotary drive mechanism (not shown), in order to secure a predetermined gap between the journal portion 2 and the semi-open saddle type high frequency induction heating coils 5 at the time when the journal portion 2 is subjected to high frequency induction heating by the semi-open saddle type high frequency induction heating coil 5. Specifically, as shown in FIG. 1 and FIG. 2, one guide chip 21a among the three guide chips 21a, 21b and 21c for high frequency induction heating coil is arranged at the upper side portion with respect to the center line of the journal portion 2 of the crankshaft 1, while the other two guide chips 21b and 21c for high frequency induction heating coil are arranged at the left and right side portions with respect to the center line of the journal portion 2. Furthermore, when the three guide chips 21a, 21b and 21c for high frequency induction heating coil are brought into contact with the outer peripheral surface of the journal portion 2, the center of the journal portion 2 is positioned with respect to the semi-open saddle type high frequency induction heating coil 5.

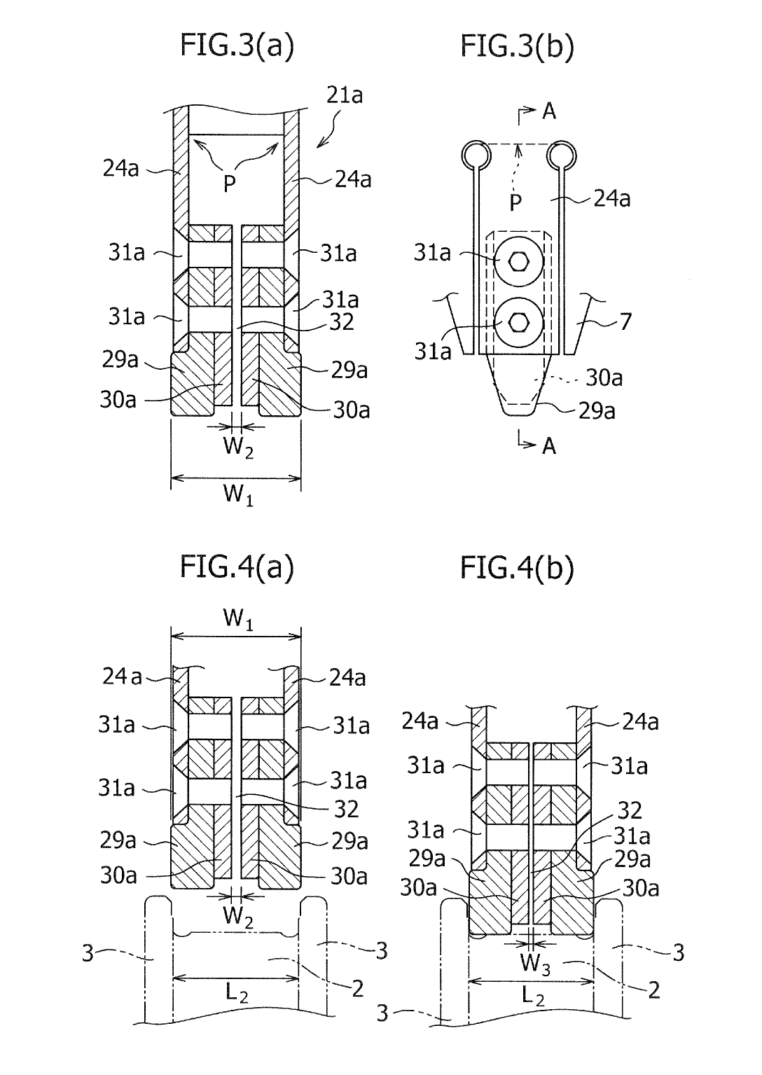

FIGS. 3(a) and 3(b) show a detailed structure of the guide chip 21a for high frequency induction heating coil, which is used in the high frequency induction heating apparatus 20. FIG. 3(b) is a side view of the guide chip 21a for high frequency induction heating coil. FIG. 3(a) is a sectional view taken along the line A-A in FIG. 3(b). Note that the arrangement positions and directions of the other guide chips 21b and 21c for high frequency induction heating coil are different from those of the guide chip 21a for high frequency induction heating coil, but the structure of the guide chips 21b and 21c for high frequency induction heating coil is substantially the same as the structure of the guide chip 21a for high frequency induction heating coil. Thus, the description of the structure of the guide chips 21b and 21c is omitted.

As shown in FIG. 2, a semicircular arc-shaped opening portion 22, in which the journal portion 2 of the crankshaft 1 is inserted and arranged, is foamed in the lower portion of the side plates 7 and 7. The distal end portions of the guide chips 21a, 21b and 21c for high frequency induction heating coil, which are configured as shown in FIGS. 3(a) and (b), are arranged so as to project into the above-described semicircular arc-shaped opening portion 22, at the upper side portion and the left and right side portions of the semicircular arc-shaped opening portion 22 of the side plates 7 and 7 (that is, at the upper portion with respect to the center line of the journal portion 2 and at the left and right portions with respect to the center line). More specifically, at the upper side portion of the semicircular arc-shaped opening portion 22 of the side plates 7 and 7, there are respectively formed a pair of slits 23 and 23 which are extended upward from the semicircular arc-shaped opening portion 22 so as to be in parallel with each other, so that the portion between the pair of slits 23 and 23 (a cantilever supported plate-shaped body having a spring function) is provided as a flexible body 24a. At the left and right side portions of the semicircular arc-shaped opening portion 22 of the side plates 7 and 7, there are formed a slit 25 and a slit 26 which are respectively extended from the semicircular arc-shaped opening portion 22 to the left and right sides thereof, and the side plate portions respectively adjacent to the slits 25 and 26 are provided as flexible bodies 24b and 24c. Furthermore, the guide chip 21a for high frequency induction heating coil is attached between the flexible bodies 24a and 24a of the side plates 7 and 7, and the guide chips 21b and 21c for high frequency induction heating coil are respectively attached between the flexible bodies 24b and 24b of the side plates 7 and 7, and between the flexible bodies 24c and 24c of the side plates 7 and 7. Therefore, in the present embodiment all of the three guide chips 21a, 21b and 21c for high frequency induction heating coil are configured so as to be flexible. Note that reference numerals 27 and 27 in FIG. 1 denote auxiliary side plates, and one slit 25 and one slit 26 are provided to each of the side plates 7 and 7 (see FIG. 2). However, the present invention is not limited to this configuration, and as in the case of the above-described slits 23 and 23, it may also be configured such that two mutually parallel slits are provided to the side plates 7 and 7 so as to sandwich each of the flexible bodies 24b and 24c.

On the other hand, as shown in FIG. 1 to FIG. 4, the guide chip 21a for a high frequency induction heating coil comprises the pair of mutually facing flexible bodies (flexible plates) 24a and 24a which are made flexible by the slits 23 and 23, chips 29a and 29a which are respectively fixed in close contact with the inner surfaces of the flexible bodies 24a and 24a, and the distal end sides of which are expanded from the flexible bodies 24a and 24a and arranged to project from the outer surface of the flexible bodies 24a and 24a, and chip fixing plates 30a and 30a which are respectively fixed in close contact with the inner surface of the chips 29a and 29a. Also, each of the fixing of the flexible bodies 24a and 24a, the fixing of the chips 29a and 29a, and the fixing of the chip fixing plates 30a and 30a is separately performed by each pair of screws 31a and 31a at positions facing each other. Note that the side plate 7 and the flexible body 24a are made of a copper alloy for a spring (phosphor bronze, beryllium copper, or the like, in the present embodiment). The chip fixing plate 30a is mainly made of a brass material, and the chip 29a is made of ceramic. However, the present invention is not limited to these.

Furthermore, as shown in FIG. 3(a), in the guide chip 21a for a high frequency induction heating coil, a gap 32 is formed between the inner surfaces of the chip fixing plates 30a and 30a in a free state in which the guide chip 21a is not inserted between the adjacent counterweight portions 3 and 3. The flexible body 24a is made flexible in the direction of reducing the gap 32 by using, as a fulcrum, a position indicated by reference character P in FIGS. 3(a) and 3(b). Thus, the flexible bodies 24a and 24a, and also the chips 29a and 29a and the chip fixing plates 30a and 30a which are respectively separately fixed to the flexible bodies 24a and 24a with the screws 31a and 31a, are configured so as to be flexible by using, as a fulcrum, the position indicated by reference character P, and configured to be elastically deformed by the elasticity of the flexible bodies 24a and 24a. Note that the width dimension W₁ (see FIG. 3(a) and FIG. 4(a)) between the external surfaces of the chips 29a and 29a is set to become larger than the width dimension L₂ (see FIG. 4(a), FIG. 4(b) and FIG. 9) of the journal portion 2 of the crankshaft 1 at the time when the guide chip 21a for high frequency induction heating coil is in the free state as shown in FIG. 3(a). In this case, when the width of the gap 32 in the free state is set as W₂ (see FIG. 3(a) and FIG. 4(a)), the width W₂ is set to satisfy the formula: (W₁−L₂)≦W₂.

On the other hand, the structure of the guide chips for a high frequency induction heating coil, which are used when applying high frequency induction heating to the pin portion 4 of the crankshaft 1, is also the same as the above-described structure of the guide chip 21a for a high frequency induction heating coil, and hence the description thereof is omitted. Of course, for the pin portion 4 of the crankshaft 1, the width dimension (not shown) between the outer surfaces of a pair of chips of the guide chip for high frequency induction heating coil, is set larger than the width dimension L₃ (see FIG. 9) between the counterweight portions 3 and 3 on both sides of the pin portion 4.

Next, there will be described an operation at the time when the journal portion 2 of the crankshaft 1 is subjected to high frequency-induction heating by the high frequency induction heating apparatus 20 including the guide chips 21a, 21b and 21c for high frequency induction heating coil, so as to be hardened. First, in order to apply high frequency induction heating to the journal portion 2 of the crankshaft 1, the high frequency induction heating apparatus 20 is moved downward by a lifting mechanism (not shown) so that the journal portion 2 is arranged in the semicircular arc-shaped opening portion 22 of the side plate 7. Thereby, the distal end portions of the guide chips 21a, 21b and 21c for high frequency induction heating coil (for example, distal end portions of the pair of chips 29a and 29a) are inserted between the counterweight portions 3 and 3 of the crankshaft 1, so as to be brought into contact with the outer peripheral surface of the journal portion 2. As described above, the width dimension W₁ of the guide chips 21a, 21b and 21c for high frequency induction heating coil in the free state is set larger than the width dimension L₂ between the counterweight portions 3 and 3 of the journal portion 2 (W₁>L₂) (see FIG. 4(a)), and hence, at this time, the flexible bodies 24a and 24a, and the like, are elastically deformed by using, as a fulcrum, the position indicated by reference character P (see FIG. 3(a) and FIG. 3(b)). Thereby, the width of the gap 32 in each of the guide chips 21a, 21b and 21c is reduced to be less than the width W₂ of the gap 32 in the free state, so as to become a width W₃. In this case, the flexible body 24a is elastically deformed to reduce the gap 32, and hence each of the pairs of the chips 29a and 29a, and the like, of the guide chips 21a, 21b and 21c for high frequency induction heating coil are brought into press contact with the inner surfaces of the counterweight portions 3 and 3 on both sides of the journal portion 2 by the elastic restoring force (elastic force in the direction of increasing the width W₃) of each of the pairs of the flexible bodies 24a and 24a, and the like. As a result, the guide chips 21a, 21b and 21c for high frequency induction heating coil and thus the semi-open saddle type high frequency induction heating coil 5 are positioned at a correct position in the width direction of the journal portion 2. That is, the semi-open saddle type high frequency induction heating coil 5 is positioned at the center position in the width direction of the journal portion 2 between the mutually adjacent counterweight portions 3 and 3.

In such a state, the crankshaft 1 is driven and rotated about the axis line thereof (the center line of the journal portion 2) by the rotary drive mechanism (not shown). Also, the high frequency induction heating apparatus 20, and thus the guide chips 21a, 21b and 21c, and the semi-open saddle type high frequency induction heating coil 5 are held by a high frequency induction heating coil following mechanism (not shown) so as to follow the rotating journal portion 2. Thereby, the journal portion 2 is subjected to high frequency induction heating by the semi-open saddle type high frequency induction heating coil 5. Thereafter, a hardening treatment is performed by spraying cooling water from the cooling water supply means 10 to the outer peripheral surface of the journal portion 2 which is high-frequency induction heated to a required hardening temperature, so that a hardened case is formed.

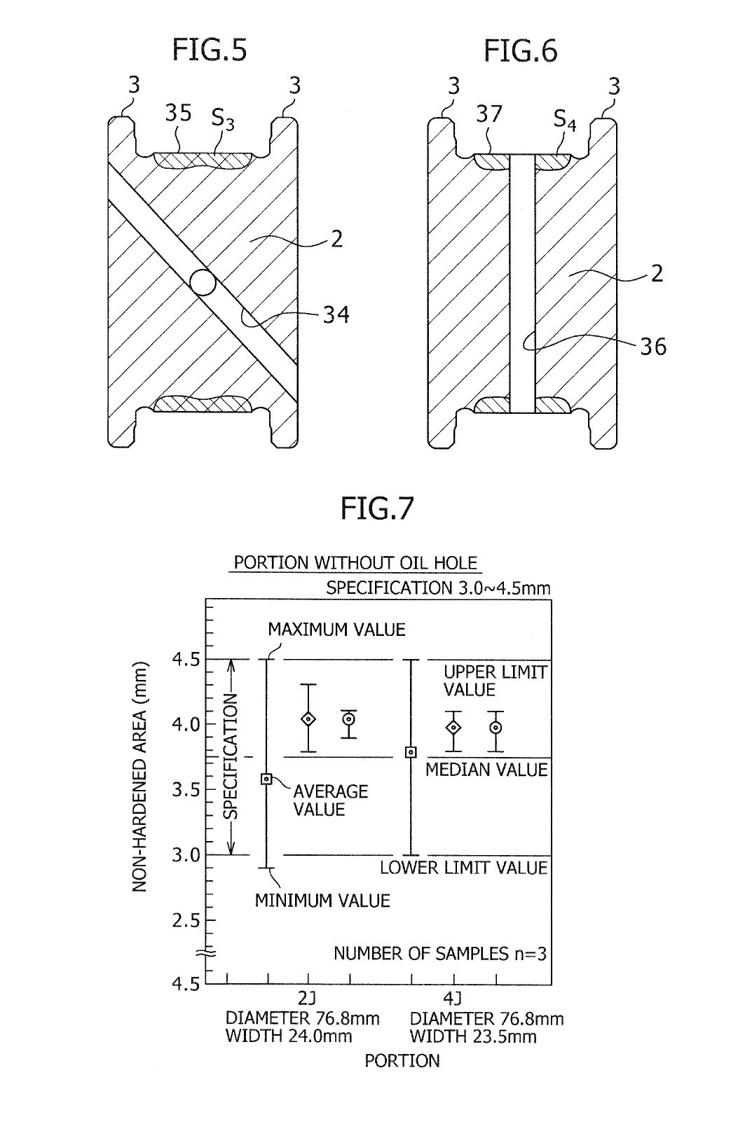

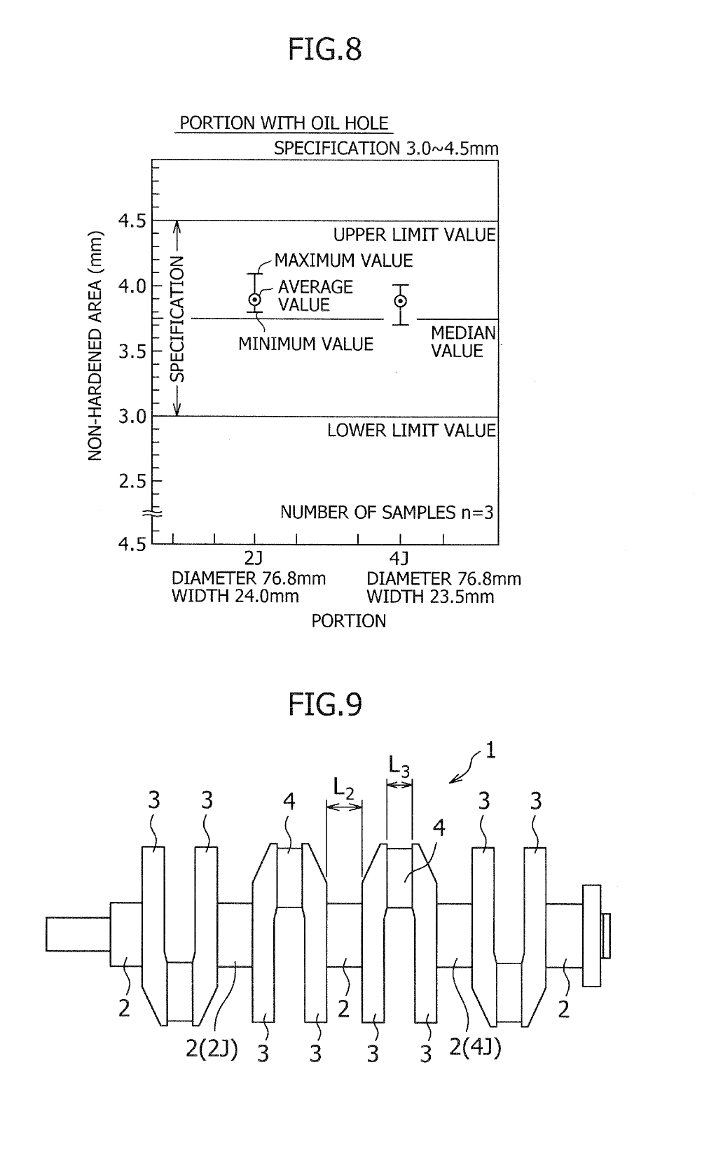

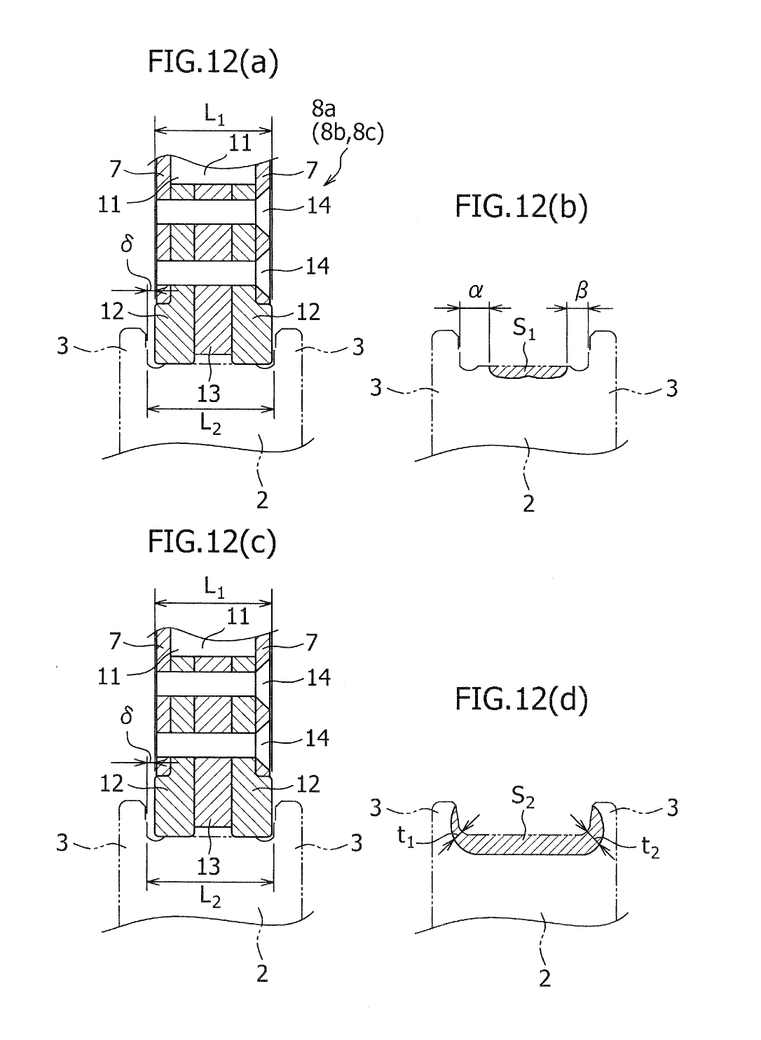

FIG. 5 shows a hardened case S₃ which is formed at the time when a portion 35 without an oil hole 34 in the journal portion 2 is subjected to high frequency induction heating so as to be hardened by using the guide chips 21a, 21b and 21c for high frequency induction heating coil. FIG. 6 shows a hardened case S₄ which is formed at the time when a portion 37 with an oil hole 36 in the journal portion 2 is subjected to high frequency induction heating so as to be hardened by using the guide chips 21a, 21b and 21c for high frequency induction heating coil. Furthermore, FIG. 7 shows non-hardened areas in the portion 35 shown in FIG. 5, and FIG. 8 shows non-hardened areas in the portion 37 shown in FIG. 6. Note that in FIG. 7 and FIG. 8, the horizontal axis represents the hardening portion, and the vertical axis represents the non-hardened area. The standard value of the non-hardened area is set in a range of 3.0 to 4.5 mm. Furthermore, in FIG. 7 and FIG. 8, the □ mark represents a case in which the conventional guide chips 8a, 8b and 8c (see FIG. 12) for high frequency induction heating coil are used, and the ⋄ mark and the ◯ mark represent cases in which the guide chips 21a, 21b and 21c for high frequency induction heating coil according to the present embodiment are used. In the figures, the ⋄ mark represents a case in which the flexible bodies 24a and 24a having a low spring constant (spring constant=5.9 kg/mm) are used, while the ◯ mark represents a case in which the flexible bodies 24a and 24a having a high spring constant (spring constant=7.8 kg/mm) are used. Here, the point represented by each of the □ mark, the ⋄ mark, and the ◯ mark corresponds to an average value in the non-hardened area. Also, the upper end of the straight line extended upwards from each of the marks corresponds to a maximum measured value in the non-hardened area, while the lower end of the straight line extended downwards from each of the marks corresponds to a minimum measured value in the non-hardened area. On the other hand, the hardening portions are the second journal portion 2 (2J) from the left of the crankshaft 1 shown in FIG. 9 and the fourth journal portion 2 (4J) from the left of the crankshaft 1 shown in FIG. 9. Note that the diameter of the second journal portion 2 (2J) is 76.8 mm and the width thereof is 24.0 mm, while the diameter of the fourth journal portion 2 (4J) is 76.8 mm and the width thereof is 23.5 mm. Therefore, the fourth journal portion 2 (4J) has a width dimension slightly smaller (−0.5 mm) than that of the second journal portion 2 (2J).

As shown in FIG. 7, it can be seen that in the case in which the conventional guide chips 8a, 8b, and 8c for high frequency induction heating coil are used, the lower limit value of the non-hardened area of the second journal portion 2 (2J) is smaller than the lower limit value of the specification, and that the non-hardened area of the fourth journal portion 2 (4J) is barely within the range of the specification. On the other hand, it can be seen from the figure that in the case in which the guide chips 21a, 21b and 21c for high frequency induction heating coil according to the present embodiment are used, the non-hardened area of the journal portion is sufficiently within the range of the specification. Furthermore, the variation in the non-hardened area tends to become comparatively large in the portion 37 with the oil hole 36 in the journal portion 2. However, it can be seen from FIG. 8 that in the case in which the guide chips 21a, 21b and 21c for a high frequency induction heating coil according to the present embodiment are used even for the portion 37 with the oil hole 36 in the journal portion 2, the non-hardened area is sufficiently within the range of the specification.

Note that FIGS. 5 and 6 show hardened cases S₃ and S₄ formed in the case in which the guide chips 21a, 21b and 21c for high frequency induction heating coil according to the present embodiment are used, and it is confirmed from the figures that the hardened cases S₃ and S₄ are formed at substantially correct positions in both the portion 35 without the oil hole 34 and the portion 37 with the oil hole 36 in the journal portion 2.

In the above, an embodiment according to the present invention has been described. However, the present invention is not limited to the embodiment, and various modifications and changes can be made within the scope and spirit of the present invention. For example, in the above-described embodiment, it is configured such that the journal portion 2 of the crankshaft 1 is subjected to high frequency induction heating so as to be hardened by using the guide chips 21a, 21b and 21c for high frequency induction heating coil, but the present invention can also be applied to the case in which the pin portion 4 of the crankshaft 1 is subjected to high frequency induction heating so as to be hardened by using the guide chips 21a, 21b and 21c for high frequency induction heating coil. Furthermore, in the above-described embodiment, the three guide chips 21a, 21b and 21c for high frequency induction heating coil are configured in a flexible manner, but only one of the guide chips may be configured in the flexible manner. Also in this case, the guide chips for high frequency induction heating coil, and thus the semi-open saddle type high frequency induction heating coil, can be correctly positioned in the width direction of the journal portion or the pin portion. Furthermore, in the above-described embodiment, it is configured such that the three guide chips 21a, 21b and 21c for high frequency induction heating coil are used, but it is possible to use two or four or more guide chips for high frequency induction heating coil. Furthermore, in the above-described embodiment, it is set such that the width of the gap 32 between the chip fixing plates 30a and 30a facing each other is reduced to become the width W₃ at the time when the guide chips 21a, 21b and 21c for high frequency induction heating coil are inserted between the mutually adjacent counterweight portions 3 and 3 (see FIG. 4(b)). However, it may also be set such that the width of the gap 32 is reduced to become zero (the gap 32 is eliminated) at that time. In the above, there has been described the structure of the guide chips for high frequency induction heating coil according to the present invention. However, the guide chip structure is not limited to the above-described structure, and it is obvious that those included in the technical scope of the present invention can be applied.

1. A structure of a plurality of guide chips for high frequency induction heating coil, which are respectively attached between a pair of side plates for supporting a semi-open saddle type high frequency induction heating coil, which, when a journal portion or a pin portion of a crankshaft is subjected to high frequency induction heating by the semi-open saddle type high frequency induction heating coil, are used for positioning the center of the journal portion or the pin portion with respect to the semi-open saddle type high frequency induction heating coil, and which are used for positioning the semi-open saddle type high frequency induction heating coil in the width direction of the journal portion or the pin portion between mutually adjacent counterweight portions of the crankshaft,
the structure being characterized in that the guide chip for high frequency induction heating coil includes: a pair of flexible bodies which have a spring function and which are respectively provided in the pair of side plates; a pair of chips which are respectively arranged and fixed in the inside of the pair of flexible bodies facing each other; and a pair of chip fixing plates which are respectively arranged and fixed in the inside of the pair of chips, and
characterized by being configured such that, in a free state in which the guide chip for high frequency induction heating coil is not inserted between the mutually adjacent counterweight portions, a gap exists between the inner surfaces of the pair of chip fixing plates facing each other, and also the width dimension between the outer surfaces of the pair of chips facing each other is set to become larger than the width dimension of the journal portion or the pin portion, and such that when the guide chip for high frequency induction heating coil is inserted between the mutually adjacent counterweight portions, the gap between the inner surfaces of the pair of chip fixing plates is reduced or eliminated by the spring function of the pair of flexible bodies.

2. The structure of the guide chips for high frequency induction heating coil according to claim 1, characterized in that the flexible body is integrally provided to the side plate by forming, in the side plate, a pair of slits that are arranged at a distance so as to face each other and extended to an opening portion of the side plate in which opening portion the journal portion or the pin portion is inserted and arranged.

3. The structure of the guide chips for high frequency induction heating coil according to one of claim 1 and claim 2, characterized in that the guide chips for high frequency induction heating coil are arranged at three places of the upper side and the left and right sides with respect to the center line of the journal portion or the pin portion, and in that the flexible body is provided at all or at least one of the three places in which the three guide chips for high frequency induction heating coil are arranged.
